(19) United States
(12) Patent Application Publication
(10) Pub. No.: US 2025/0245657 A1
(43) Pub. Date: Jul. 31, 2025

(54) SYSTEMS AND METHODS TO AUDIT PURCHASES AT A STORE

(71) Applicant: Walmart Apollo, LLC, Bentonville, AR (US)

(72) Inventors: Syed Kashif Mujtaba Kamoonpuri, Dallas, TX (US); Pratik Kanungo, Khargone (IN); Jigar A. Mistry, Ahmedabad (IN); Yogananda Domlur Seetharama, Baton Rouge, LA (US); Syed A. Ahmad, Mckinney, TX (US); Atul Joshi, Bengaluru (IN); Venkata P. Boggavarapu, Coppell, TX (US)

(21) Appl. No.: 18/429,035

(22) Filed: Jan. 31, 2024

(51) Int. Cl. G06Q 20/40; G06Q 20/18; G06Q 20/20; G06Q 20/32

(52) U.S. Cl. CPC G06Q 20/40; G06Q 20/18; G06Q 20/20; G06Q 20/3267

(57) ABSTRACT

In some embodiments, apparatuses and methods are provided herein useful to auditing purchases at a store. In some embodiments, there is provided a system for auditing purchases at a store including: a control circuit and a user interface operable on an electronic device. The control circuit configured to: receive purchase data; assign a score to a sales transaction; assign, based on at least the score, a quantity of items to be verified by a worker prior to the customer leaving the store; and output transaction data comprising at least a transaction identifier associated with the sales transaction and the quantity of the items to be verified by the worker. The user interface configured to: receive the transaction data from the control circuit; and display instructions to the worker indicating the quantity of items of the sales transaction to be verified.

### TECHNICAL FIELD

This invention relates generally to auditing purchases at a store, more specifically, to auditing purchases at a store prior to a customer leaving a store.

### BACKGROUND

There are several options to pay for items at a store. For example, a customer may choose to checkout at a point of sale (POS) station. In another example, a customer may checkout at a self-checkout counter. In another example, a customer may use a mobile application on a customer's mobile device to pay for items before leaving a store. However, at times, customers may intentionally or unintentionally exit the store with unpaid item/s intermixed with paid items, thereby contributing to lost inventory and lost revenue to the store. To minimize the chance of this occurring, some stores provide a store associate at the exit to manually check customer receipts and purchased items prior to the customer leaving the store. However, checking items on a receipt with items either carried by the customer or inside customer's cart can result in lines at the exit and delay the customer exiting the store.

### BRIEF DESCRIPTION OF DRAWINGS

Disclosed herein are embodiments of systems, apparatuses and methods pertaining to auditing purchases at a store. This description includes drawings, wherein:

FIG. 1 illustrates a simplified block diagram of an exemplary system for auditing purchases at a store in accordance with some embodiments;

FIG. 2 shows a flow diagram of an exemplary method of auditing purchases at a store in accordance with some embodiments;

FIG. 3 shows an illustrative example process of auditing purchases at a store in accordance with some embodiments;

FIG. 4 shows a flow diagram of an exemplary method of auditing purchases at a store in accordance with some embodiments;

FIGS. 5A-5B together show a flow diagram of an exemplary method of auditing purchases at a store in accordance with some embodiments;

FIG. 6 illustrates example attributes that can be used in a determination of a score in accordance with some embodiments;

FIG. 7 illustrates an example variable scan approach in accordance with some embodiments;

FIG. 8 shows illustrative examples of associate behavior in FIG. 6 in accordance with some embodiments;

FIG. 9 shows an exemplary attribute used in verification of fairness in auditing purchases at a store in accordance with some embodiments;

FIG. 10 shows an illustrative example of using a dynamic threshold approach in auditing purchases at a store in accordance with some embodiments; and

FIG. 11 illustrates an exemplary system for use in implementing methods, techniques, devices, apparatuses, systems, servers, sources and auditing purchases at a store in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for auditing purchases at a store. In some embodiments, a system for auditing purchases includes a control circuit and a user interface. The control circuit may be operatively coupled to the user interface. The control circuit may receive purchase data corresponding to a plurality of items collected in the store and purchased by a customer in a sales transaction using a point of sale mechanism. Alternatively or in addition, the control circuit may assign a score to the sales transaction. Alternatively or in addition, the control circuit may assign, based on at least the score, a quantity of items to be verified by a worker prior to the customer leaving the store. In some embodiments, the quantity of items includes a number and selected from any one of a plurality of numbers. Alternatively or in addition, the control circuit may output transaction data including at least a transaction identifier associated with the sales transaction and the quantity of the items to be verified by the worker. In some embodiments, the user interface is operable on an electronic device associated with the worker proximate an exit of the store. In some embodiments, the user interface receives the transaction data from the control circuit, and displays instructions to the worker indicating the quantity of items of the sales transaction to be verified.

In some embodiments, a method for auditing purchases at a store including receiving, by a control circuit, purchase data corresponding to a plurality of items collected in the store and purchased by a customer in a sales transaction using a point of sale mechanism. Alternatively or in addition, the method may include assigning, by the control circuit, a score to the sales transaction. Alternatively or in addition, the method may include assigning, by the control circuit and based on at least the score, a quantity of items to be verified by a worker prior to the customer leaving the store. Alternatively or in addition, the method may include outputting, by the control circuit, transaction data including at least a transaction identifier associated with the sales transaction and the quantity of the items to be verified by the worker. Alternatively or in addition, the method may include receiving, from the control circuit and at a user interface operable on an electronic device associated with the worker proximate an exit of the store, the transaction data. Alternatively or in addition, the method may include displaying, by the user interface, instructions to the worker indicating the quantity of items of the sales transaction to be verified.

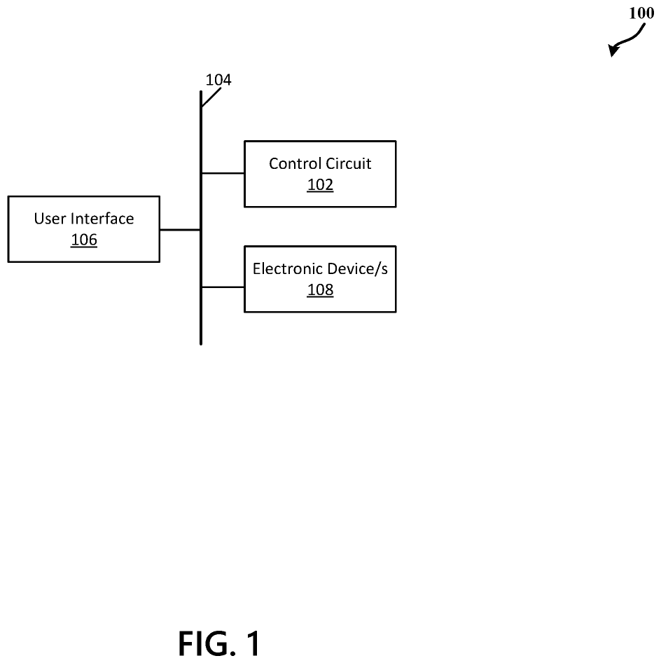

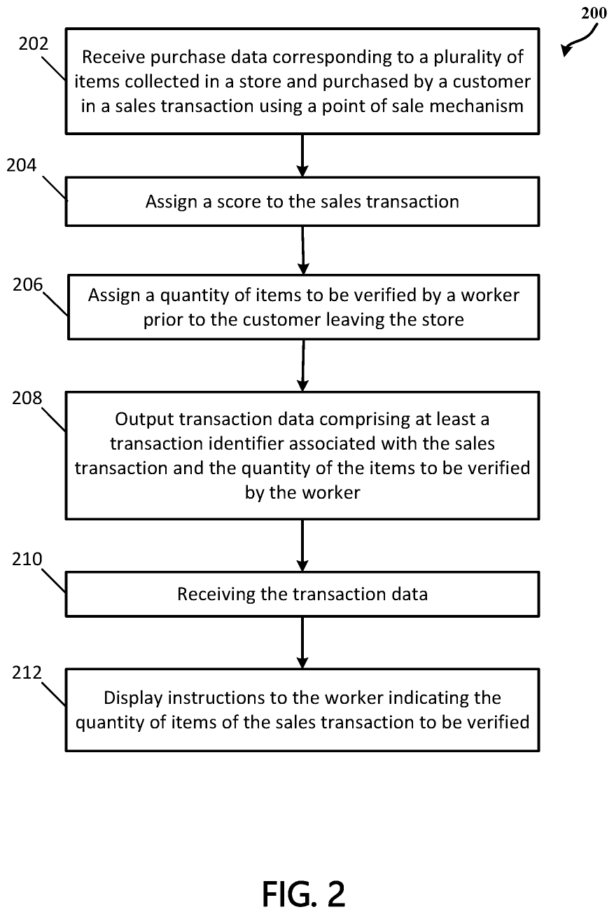

FIG. 1 illustrates a simplified block diagram of an exemplary system 100 for auditing purchases at a store in accordance with some embodiments. FIG. 2 shows a flow diagram of an exemplary method 200 of auditing purchases at a store in accordance with some embodiments. The system 100 includes a control circuit 102 operatively coupled to user interface 106, and/or electronic device/s 108 via a communication network 104. In some embodiments, the communication network 104 includes wired and/or wireless network, an Internet, WIFI, local area network (LAN), wide area network (WAN), cloud networking, and/or any one or more combination of communication networks that allows one electronic device and/or component to communicate with another electronic device/s and/or components.

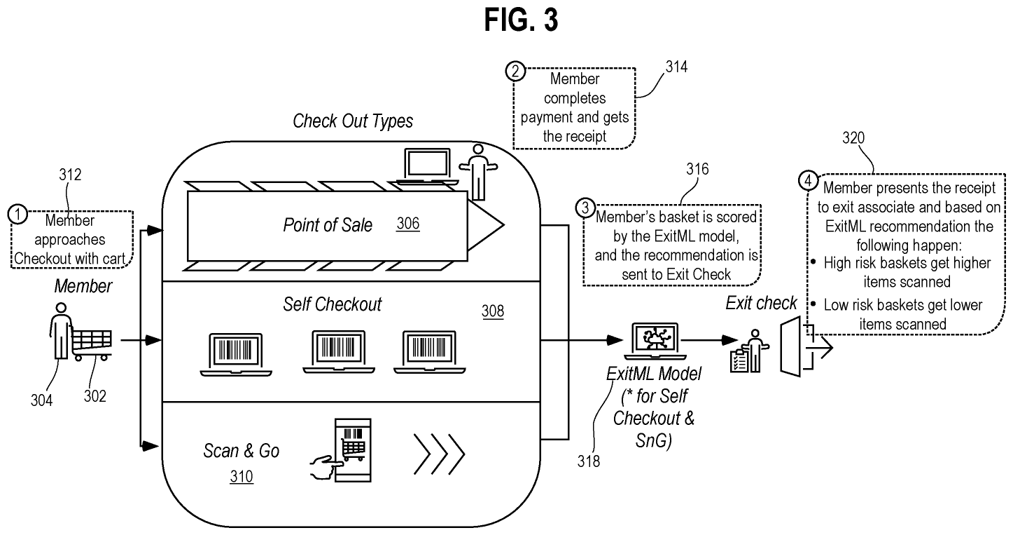

In some embodiments, at step 202, the control circuit 102 receives purchase data corresponding to a plurality of items collected in a store and purchased by a customer in a sales transaction using a point of sale mechanism. For example, the point of sale mechanism may include at least one of a self-checkout station, a cashier assisted checkout station, and a mobile checkout application for use with an electronic device of the customer. In an illustrative non-limiting example, the plurality of items collected and purchased by the customer in the store may be stored in a shopping container (e.g., shopping container 302 shown in FIG. 3) while the customer is shopping at the store. The shopping container 302 may include a carried basket or bag, a mobile cart, trolley, and/or a pallet, to name a few. In some embodiments the score may be associated with the shopping container 302. In some embodiments, some or all of the purchased items may be carried by the customer without a shopping container. After the customer completes the sales transaction (e.g., payment for the purchased items has been received and accepted) at a point of sale mechanism, the control circuit 102 may receive the purchase data and/or stores the purchase data along with a corresponding transaction identifier associated with the sales transaction. In some embodiments, the transaction identifier is associated with a customer identification and/or a store identification.

Alternatively or in addition, at step 204, the control circuit 102 may assign a score to the sales transaction. In some embodiments, the control circuit 102 assigns the score based on at least one or more of: a composition of the plurality of items, one or more attributes associated with the store, and one or more attributes associated with the worker.

Alternatively or in addition, at step 206, based on at least the score, the control circuit 102 may assign a quantity of items to be verified by a worker prior to the customer leaving the store. Alternatively or in addition, at step 208, the control circuit 102 may output transaction data including at least a transaction identifier associated with the sales transaction and the quantity of the items to be verified by the worker. In some embodiments, the transaction data may include data corresponding to the purchased items (e.g., item identifier, UPC code, to name a few). In some embodiments, the control circuit 102 may cause the transaction data to be stored in the Cosmos DB (of an external team that maintains the Exit App) and then transmitted to the user interface 106 to be stored in a local memory and/or cache of one or more electronic devices 108. In some embodiments, at step 210, the user interface 106 operable on an electronic device associated with the worker proximate an exit of the store receives from the control circuit 102 the transaction data. Alternatively or in addition, at step 212, the user interface 106 may display instructions to the worker indicating the quantity of items of the sales transaction to be verified. In some embodiments, the control circuit 102 outputs transaction data for each of a plurality of sales transactions to the user interface 106. The user interface 106 may receive and store the transaction data for each of the plurality of sales transactions.

In some embodiments, a user interface 106 is operable on one or more electronic devices 108 associated with one or more workers proximate an exit of the store. For example, the user interface 106 may include an application associated with a retailer and/or downloaded to and installed on the one or more electronic devices 108. In another example, the user interface 106 may cause a display or display unit of an electronic device 108 to show or display communications or instructions associated with the transaction data received from the control circuit 102. In some embodiments, the user interface 106 may include the display or display unit. In some embodiments, an electronic device 108 may include a smartphone, a tablet, a laptop, a fixed electronic device, and/or a portable electronic device.

In some embodiments, after the sales transaction is completed, a paper receipt and/or an electronic receipt may be provided to the customer prior to the customer leaving the point of sale mechanism. For example, the paper receipt and/or the electronic receipt may include a barcode, a QR code, and/or any electronic code capable to be read by a sensor (not shown). In some embodiments, the sensor includes a scanner and/or a camera of an electronic device 108. In an illustrative non-limiting example, the user interface 106 may obtain a transaction identifier associated with the sale transaction from either a paper receipt or an electronic receipt presented to the worker by the customer. For example, once the sensor obtains the electronic code corresponding to the transaction data, the user interface 106 may retrieve the quantity of items of the sales transaction from the transaction data having a matching transaction identifier.

For example, the control circuit 102 receives purchase data from a multiple sales transactions. By one approach, for each completed sales transaction, a corresponding transaction identifier is generated. In some embodiments, for each sales transaction, the control circuit 102 assigns a score to the sales transaction, assigns a quantity of items to be verified by a worker prior to the customer leaving the store, and outputs transaction data to the user interface 106. In some embodiments, the transaction data includes a customer identifier, a store identifier, a transaction identifier, and/or the assigned quantity of items to be verified.

FIG. 3 shows an illustrative example of auditing purchases at a store in accordance with some embodiments and is referred to while also referring to FIG. 2. For example, at stage one 312, a customer or a member 304 has collected items to be purchased that are contained within a shopping container 302. In some embodiments, the customer/member 304 may be carrying the items to be purchased instead of having a shopping container 302. At stage two 314, the customer/member 304 may choose from a number of ways to pay for the items. For example, a customer may complete the purchase via one of a point of sale station or a cashier assisted checkout station 306, a self checkout station 308, or via a mobile application and mobile device (e.g., using Walmart's or Sam's Club's Scan & Go application) 310. The customer completes the payment and may then receive a physical receipt and/or an electronic receipt. Either receipt may include a barcode, a QR code, and/or any electronic code capable to be read by a sensor of an electronic device 108 and that may identify the transaction identifier and/or the customer identifier. At stage three 316, the control circuit 102 may assign a score to the sales transaction, assigns a quantity of items based at least on the score to be verified by a worker prior to the customer leaving the store, and/or outputs transaction data to the user interface 106. At stage three 320, the customer/member 304 may present a receipt to the worker. In an illustrative non-limiting example, the worker may scan the receipt using the user interface 106 via a sensor of an electronic device 108 used by the worker. In some embodiments, the sensor may be a standalone device proximate an exit of the store.

In some embodiments, after a transaction identifier associated with the sales transaction is obtained from a receipt by the user interface 106, the user interface 106 may retrieve the quantity of items of the sales transaction from the transaction data having a matching transaction identifier. For example, the control circuit 102 outputs multiple transaction data associated with a plurality of sales transactions completed to the user interface 106. In some embodiments, the multiple transaction data are stored in a local memory of the electronic device 108. As such, when the user interface 106 obtains a transaction identifier from a receipt, the user interface 106 may readily access the local memory and perform a lookup on the quantity of items to be verified by the worker from the transaction data having a matching transaction identifier. In some embodiments, for each stored transaction identifier in the local memory, a corresponding customer identifier and a corresponding quantity of items to be verified by the worker are associated with the stored transaction identifier. In some embodiments, the transaction data output by the control circuit to the user interface includes at least a transaction identifier associated with the sales transaction and the quantity of the items to be verified by the worker proximate an exit of the store.

In some embodiments, in assigning a score to a sales transaction, the control circuit 102 may execute a trained machine learning model (e.g., ExitML Model) 318 to determine the score. In some embodiments, the trained machine learning model 318 may include supervised, semi-supervised, unsupervised, reinforcement machine learning algorithms, and/or any publicly known machine learning algorithms capable of executing functions described herein, such as to audit purchases at a store.

In some embodiments, the control circuit 102 may associate the determined score to a corresponding sales transaction and/or a corresponding shopping container 302. In such embodiments, the determined score is particular to the corresponding sales transaction and/or the corresponding shopping container 302. For example, each sales transaction and/or each shopping container 302 may be associated with a corresponding score determined based at least on items or composition of the items associated with the sales transaction, items or composition of the items stored in the shopping container 302, attributes associated with a worker proximate an exit, and/or attributes associated with the store the items were bought.

In some embodiments, the assignment of the quantity of items to be verified is based on the determined score. For example, a particular threshold of a score may correspond to a sales transaction and/or a shopping container 302 having a high probability or risk of having items that may not have been paid for. In an illustrative non-limiting example, the sales transaction and/or the shopping container 302 may include a USB flash drive and a necklace along with a few grocery items. The control circuit 102 may determine that the USB flash drive and the necklace may be associated with one or more categories that have high probability or risk of not being paid for. In such example, the control circuit 102 may assign a particular quantity of items for a worker to verify. In another example, another particular threshold of score may correspond to a sales transaction and/or a shopping container 302 having a low probability or risk of having items that may not have been paid for. In an illustrative non-limiting example, the sales transaction and/or the shopping container 302 may include a 60 inch TV. The control circuit 102 may determine that the 60 inch TV may be associated with a category that has a low probability or risk of not being paid for. In such example, the control circuit 102 may assign another particular quantity of items for a worker to verify. In some embodiments, the assigned quantity of items associated with a low probability or risk is lower than the assigned quantity of items associated with a higher probability or risk. In an illustrative non-limiting example, the assigned quantity of items associated with a low probability or risk may correspond to two items while the assigned quantity of items associated with a higher probability or risk may correspond to five items.

In some embodiments, the user interface 106 receives scan data corresponding to each of the quantity of items from a scanner of the electronic device. Alternatively or in addition, the user interface 106 may determine whether the scan data of each of the items matches ones of the plurality of items purchased by the customer in the sales transaction. In some embodiments, the user interface 106 may output and display, in the event the scan data of the quantity of items matches with the plurality of items, a first notification to the worker via the user interface 106 that the sales transaction is verified. In some embodiments, the user interface 106 may output and display, in the event the scan data of at least one item not matching the plurality of items, a second notification to the worker via the user interface 106 that an item has not been paid for by the customer.

In some embodiments, the user interface 106 displays instructions on an electronic device 108 associated with a worker proximate an exit of a store. The instructions may indicate the quantity of items to be verified. For example, the user interface 106 may cause a display (e.g., display unit, display device, a display interface, or monitor) coupled to the electronic device 108 to display the quantity of items to be verified. In some embodiments, the instructions displayed to the worker proximate the exit of the store do not specify particular or specific items to verify. For example, the instructions may indicate for the worker to check or scan 2 items. However, the instructions may not indicate which particular items to check (e.g., check a can of corn and a toothpaste). In some embodiments, the presentation or the scanning of the receipt causes the transmission of a signaling or a triggering of the user interface 106 to display the instructions. In some embodiments, scanning of an item selected by the worker for verification or scanning of a barcode or an item identifier or an item electronic code found on the item selected by the worker triggers a lookup of data corresponding to the selected item.

In some embodiments, the user interface 106 may use the data corresponding to the selected item to determine whether the scanned item is one of the purchased items associated with the corresponding transaction identifier. By one approach, if the user interface 106 determines that the scanned item is one of the purchased items associated with the corresponding transaction identifier, the user interface 106 may display a message that may correspond to the determination. For example, the message may include an indication (e.g., a text message or a visual indication) that the scanned item is on the receipt. By another approach, if the control circuit 102 determines that the scanned item is not one of the purchased items associated with the corresponding transaction identification, the user interface 106 may display a message that may correspond to the determination. For example, the message may include an indication (e.g., a text message or a visual indication) that the scanned item is not on the receipt.

In an illustrative non-limiting example, a plurality of sales transactions may be executed at a period of time. In such example, each sales transaction may be audited as described herein. In some embodiments, the control circuit 102 outputs transaction data to the user interface 106. For example, the transaction data may include at least the quantity of items of the sales transaction to be verified and a corresponding transaction identification associated with the sales transaction. In some embodiments, for each customer who completed a purchase, an electronic device 108 associated with a worker proximate an exit of the store may receive a corresponding transaction data including at least a quantity of items of the sales transaction to be verified and a corresponding transaction identifier associated with the sales transaction. In some embodiments, a particular score assigned to a sales transaction and/or a shopping container 302 may cause the control circuit 102 to assign a particular quantity of items to be verified. In some embodiments, when a score corresponds to a value within a particular range of score, the score may indicate that the corresponding sales transaction and/or shopping container 302 may be considered high risk causing the control circuit 102 to instruct a higher quantity of items to be verified. In some embodiments, when a score corresponds to a value within another particular range of score, the score may indicate that the corresponding sales transaction and/or shopping container 302 may be considered low risk causing the control circuit 102 to instruct a lower quantity of items to be verified. In some embodiments, data corresponding to associations of scores with specific quantity of items to verify are stored in a database (not shown). In some embodiments, the trained machine learning model 318 may be trained to determine to assign a quantity of items based on the determined or assigned score.

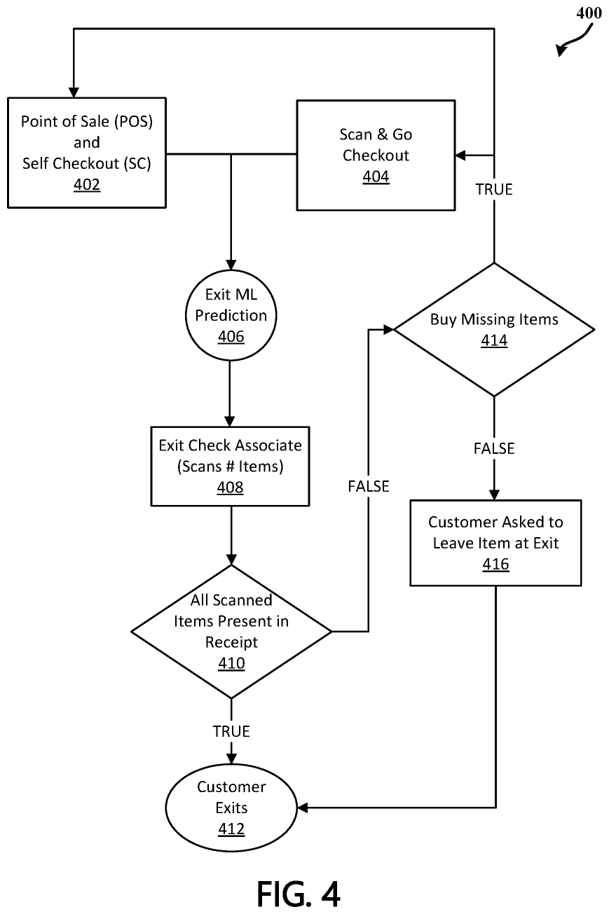

FIG. 4 shows a flow diagram of an exemplary method 400 of auditing purchases at a store in accordance with some embodiments. For example, the method 400 may, at step 402, include a customer 304 completing its purchase of items at one of the checkout areas at the store (e.g., POS 306 or SC 308). Alternatively or in addition, the method 400 may, at step 404, include a customer 304 completing its purchase of items using a mobile checkout application or a retailer's app (e.g., Scan & Go) 310 used with an electronic device 108 of the customer 304. In using the retailer's app 310, the customer 304 may scan the items to be purchased while strolling through the store in such a way that when the customer 304 finishes collecting items to be purchased, the customer 304 may use the retailer's app and complete the purchase without having to stop at a checkout area in the store. Alternatively or in addition, the method 400 may, at step 406, include initiating a trained machine learning algorithm (e.g., Exit ML Prediction) 318. In some embodiments, the control circuit 102 may execute the trained machine learning model 318 in response to receiving purchase data corresponding to a plurality of items collected in the store and purchased by a customer in the sales transaction using a point of sale mechanism.

Alternatively or in addition, the trained machine learning model 318 may determine and/or assign a score to the sales transaction and/or to the shopping container 302, and based on at least the score, assign a quantity of items for the exit check associate or worker 304 to verify prior to the customer leaving the store. For example, the user interface 106 operable on the electronic device 108 associated with the exit check associate/worker 304 may display a message instructing the exit check associate/worker 304 to verify a quantity of items either carried by the customer or inside the shopping container 302. For example, the exit check associate/worker 304 may, at step 408, randomly pick an item to verify until the exit check associate/worker 304 satisfy the instructed quantity of items. In some embodiments, the exit check associate/worker 304 may use the electronic device 108 to scan the item or scan a barcode/an item electronic code/an item identifier affixed on the item selected by the exit check associate/worker 304 to verify. In such embodiments, the user interface 106 operable on the electronic device 108 may perform a lookup on a local memory of the electronic device 108 to determine whether the item selected by the exit check associate/worker 304 is among those items associated with the received data corresponding to the items collected and purchased by the customer. In some embodiments, the transaction data output by the control circuit 102 to the user interface 106 may include data corresponding to the item identifiers of the items purchased by the customer. By one approach, the transaction data is stored in a memory accessible by the electronic device 108 used by the worker proximate an exit of the store.

Alternatively or in addition, at step 410, after the user interface 106 determines that the instructed quantity of items have been scanned and determines that all scanned items are among those items associated with the received transaction data, the user interface 106 may, at step 412, display a message. The message may correspond to an indication that the customer may exit the store and/or that all items carried by the customer 304 and/or stored in the shopping container 302 associated with the customer 304 have been purchased or paid for.

Alternatively or in addition, after the user interface 106 determines that the instructed quantity of items have been scanned and determines that one or more scanned items are not among those items associated with the received transaction data, the user interface 106 displays a message instructing the worker to communicate to the customer 304 that the one or more of the scanned items have not been purchased and, at step 414, to complete its purchased either by proceeding to one of the checkout areas (e.g., POS 306 and SC 308) or via the retailer's app (e.g., Scan & Go) 310. Alternatively or in addition, the customer 304 may, at step 416, choose to leave the unpaid one or more scanned items before exiting.

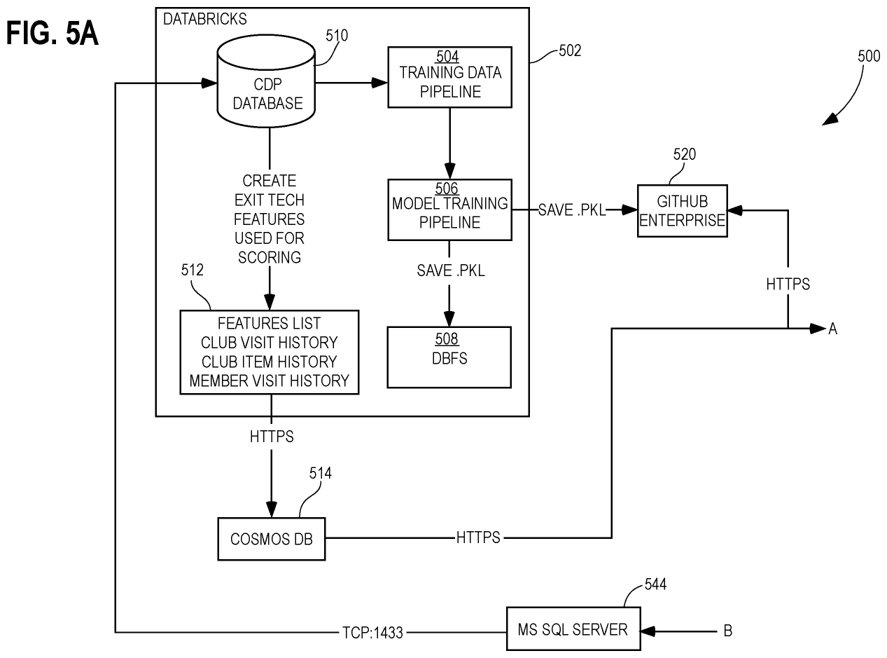

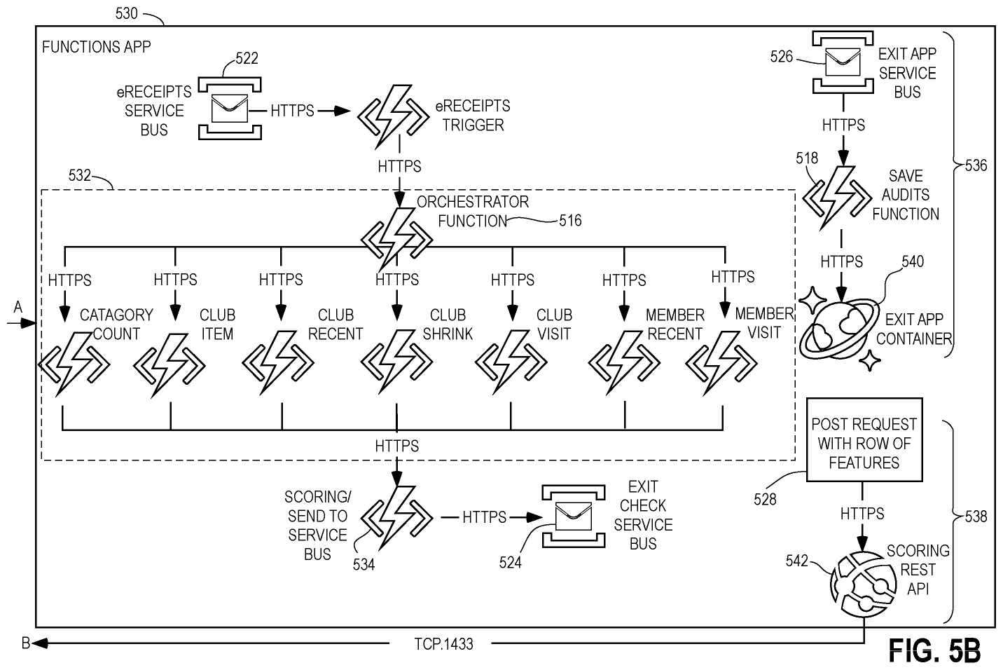

FIGS. 5A-5B together show a flow diagram of an exemplary method 500 of auditing purchases at a store in accordance with some embodiments. FIG. 5B is a continuation of FIG. 5A. In some embodiments, one or more steps in the method 500 may be executed by the control circuit 102. In some embodiments, the method 500 may include steps for training a machine learning model as shown in databricks 502. For example, the method 500 may, at step 504, include training data pipeline. Alternatively or in addition, the method 500 may, at step 506, include model training pipeline. Alternatively or in addition, the method 500 may, at step 508, include storing the model output at step 506 into a first database (e.g., DBFS). Alternatively or in addition, the method 500 may, at step 510, include accessing training data from a second database (e.g., CDP database) and using the accessed training data as input to training data pipeline at step 504. Alternatively or in addition, the method 500 may, at step 512, include accessing the second database to create a plurality of features used in determining the score to associate with a sales transaction and/or the shopping container 302. In an illustrative non-limiting example, using the transaction and audit feedback data stored in the CDP database (at step 510), training data (at step 504) is created that is used to retrain the machine learning model (at step 506) on latest data. At step 506, the model training pipeline may perform hyper-parameter tuning and model evaluation. In response, the best model may be selected and stored in DBFS as a .pkl file (at step 508). The tables stored in CDP database (at step 510) may also used to create features, such as club-visit, club-item and member-visit history features (at step 512), which are then transferred to Cosmos DB (at step 514) every night for real time inference.

Alternatively or in addition, the method 500 may, at step 514, include storing the created plurality of features in a third database (e.g., Cosmos DB). In some embodiments, the method 500 may include steps to audit purchases at a store using the trained machine learning model (e.g., ExitML Model) 318 as shown in Functions App 530. For example, the method 500 may, at step 522, include running eReceipts Service Bus. In some embodiments, when the eReceipts Service Bus is triggered, the method 500 may, at step 532, initiate execution of an Orchestrator Function 516. In some embodiments, the Orchestrator Function 516 may determine the plurality of features use in determining a score to associate with a sales transaction and/or a shopping container 302. For example, the Orchestrator Function 516 may access the third database (e.g., Cosmos DB) to determine the plurality of features. In some embodiments, the plurality of features may include category count, club item, club recent, club shrink, club visit, member recent, and/or member visit, to name a few. In some embodiments, the club item, the club recent, and so forth are functions that create a group of functions. In some embodiments, the Orchestrator Function 516 may determine and/or assign the score. In some embodiments, the Orchestrator Function 516 may, at step 534, send the score to an Exit Check Service Bus 524.

Alternatively or in addition, the method 500 may, at step 536, in response to the Exit Check Service Bus 524 receiving the score, initiates Exit App Service Bus 526. In some embodiments, the initiation of the Exit App Service Bus 526 causes Save Audits Function 518 to be executed. For example, the trained machine learning model 318 may output signaling to cause the user interface 106 to display instructions to a worker proximate an exit of the store indicating a quantity of items to be verified. In some embodiments, Exit App Container 540 contains audit feedback which may be used to create member and/or club recent features.

In some embodiments, the method 500 may, at 538, include execution of a POST Request with Row of Features 528. In executing the POST Request with Row of Features 528, the scores along with corresponding sales transactions are stored in the second database (e.g., CDP database) and/or may be accessed to determine the trained machine learning model's 318 performance against a predetermined performance requirements, and/or used in a determination of updating and/or improving the trained machine learning model 318. In some embodiments, the GitHub Enterprise 520 may store the trained machine learning model 318 and/or a copy of the trained machine learning model 318 in order for the control circuit 102 to access the trained machine learning model in auditing purchases at a plurality of stores. In some embodiments, Scoring Rest API 542 may be used to check a probability score of a particular receipt when a feature array is passed to it. In some embodiments, MS SQL Server 544 may be used to store the feature array and probability score of each transaction that was scored by the trained machine learning model 318 in real time. In some embodiments, these feature arrays are then transferred to Databricks 502 workspace for analysis and model retraining.

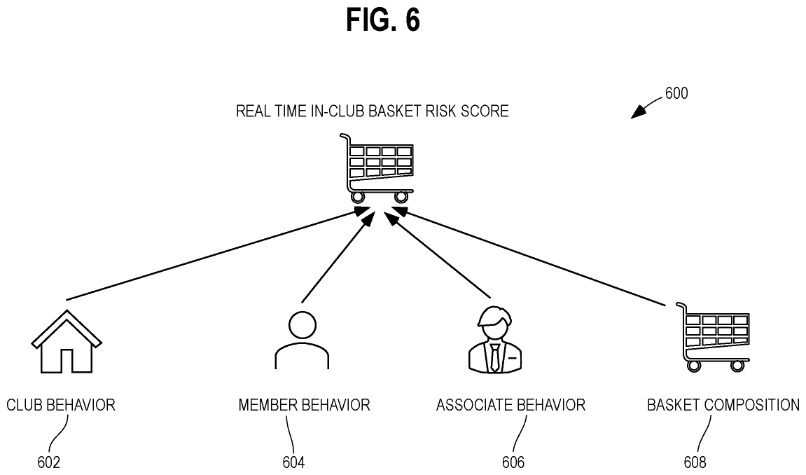

FIG. 6 illustrates example attributes 600 that can be used in a determination of a score in accordance with some embodiments. For example, a determination and/or an assignment of a score may be based on at least one of a composition of a plurality of items (e.g., basket composition 608), one or more attributes associated with the store (e.g., club behavior 602), or one or more attributes associated with the worker (e.g., associate behavior 606). For example, the score may be based at least on a determination that a threshold portion of the items purchased by the customer (e.g., those items associated with a receipt) may belong to one of categories of items (e.g., based at least on a determination of basket composition 608). The categories of items may include electronics, (non-pharmacy) medicines, school supplies, high ticket items, jewelries, sports drink and beverages, cleaning supplies to name a few. In some embodiments, the attributes 600 shown in FIG. 6 may correspond to and/or a subset of the plurality of features described in FIGS. 5A-5B.

In an illustrative non-limiting example, the attributes 600 may include club behavior 602, member behavior 604, associate behavior 606, and/or basket composition 608. For example, club behavior 602 may corresponds to data trends and/or historical data associated with loss inventories and/or occurrence of shrink in a store. Member behavior 604 may correspond to a customer's previous occurrences of having been audited and found to have one or more unpaid items in its possession or stored in associated shopping container 302. Associate behavior 606 may correspond to previous occurrences of a worker inaccurately flagging a plurality of sales transactions and/or shopping containers 302 as having unpaid items. Basket composition 608 may correspond to categories and corresponding degree of make up of the items associated with a sales transaction and/or stored in a shopping container 302 of a customer.

In some embodiments, a control circuit 102 may determine that a threshold portion of the plurality of items purchased by a customer may belong to one of categories of items that has a high likelihood of shrink. For example, a database 110 may store association of a corresponding risk value with each category of a plurality of categories of items. In an illustrative non-limiting example, the control circuit 102 and/or the trained machine learning model 318 may determine, for each purchased item, a category that an item belongs. The control circuit 102 and/or the trained machine learning model 318 may group items belonging to the same category and determine that one or more determined group of items belong to categories predetermined to have a high likelihood of shrink relative to the other categories. In some embodiments, the control circuit 102 and/or the trained machine learning model determines and/or assigns a score to associate with the sales transaction and/or the shopping container 302 based at least in part on the determined basket composition 608 of the purchased items. In some embodiments, each category of the categories of items is associated with a corresponding quantity of items to be verified by a worker prior to a customer leaving a store. In such embodiments, a score is correlated with the quantity of items to be verified by the worker prior to the customer leaving the store. The correlation of the score with the quantity of items may be varied based on at least one of a day of a week the items are purchased or the store the items were purchased.

In some embodiments, the quantity of items to verify may be based on a category of items most represented in the determined basket composition 608 of the purchased items. For example, if the customer has purchased mostly electronic items, the control circuit 102 may assign a score to the sales transaction and/or the shopping container 302 based on the score associated with the electronic category. In some embodiments, the trained machine learning model 318 looks at variety of attributes to determine basket risk including order amount, number of items purchased, membership history, club history, to name a few. For example, a transaction from a member having 3 items in the basket (e.g., belonging to 3 distinct categories) may have lower risk according to the trained machine learning model 318 as compared to the same member having 10 items in the basket (e.g., belonging to the same 3 distinct categories) because the latter basket has higher purchased items. In some embodiments, the control circuit 102 may assign a quantity of items to verify based on the assigned score. In some embodiments, the control circuit 102 may assign a quantity of items to verify based on the determined category.

In some embodiments, a machine learning model may be trained to determine a particular risk level to associate with each of the club behavior 602, the member behavior 604, the associate behavior 605 and/or the basket composition 608 based on the purchased items associated with the sales transaction and/or stored in the shopping container 302, the store the purchased items were bought, the worker that audited the purchased items, and/or the customer that made the purchased. In some embodiments, the control circuit 102 may execute the trained machine learning model 318 to determine the assignment of the score.

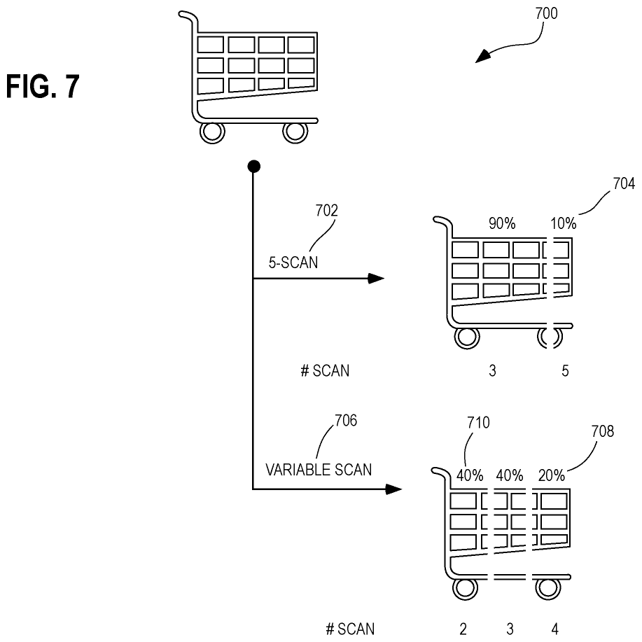

FIG. 7 illustrates example variable scan approach 700 in accordance with some embodiments. For example, the trained machine learning model may be trained to capture higher failed items and/or lower failed items. For example, a database 110 may store data corresponding to a percent ranking or a decile ranking of items based on the items' likelihood of being categorized as lost inventory or shrink (e.g., the items may have been stolen, damaged, and/or lost track). In an illustrative non-limiting example, the trained machine learning model 318 may be trained with a 5-scan approach 702. The 5-scan approach 702 may correspond to a goal that the trained machine learning model 318 captures higher failed items in the 10^{th} decile 704. In another illustrative non-limiting example, the trained machine learning model 318 may be trained with the variable scan approach 706. The variable scan approach 706 may correspond to a goal that the trained machine learning model 318 captures higher failed items in the top 2 decile 708 and the lower failed items in the bottom 4 deciles 710. In some embodiments, the control circuit 102 and/or the trained machine learning model 318 may variably assign the quantity of items to verify based on the trained machine learning model's 318 assessment of its performance in capturing higher failed items while reducing customers' dwell time (e.g., an average length of time a customer has to wait for a worker to audit the purchased items). In some embodiments, once the model is deployed, the low and high risk thresholds for variable scanning are dynamically updated everyday (based on historical model scores) ensuring consistent model performance.

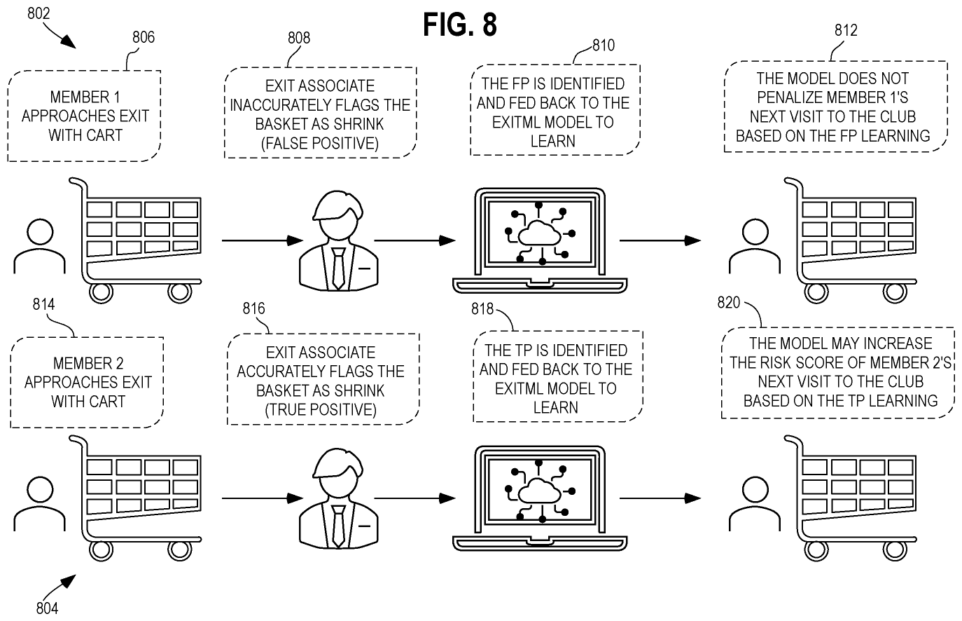

FIG. 8 shows illustrative examples of associate behavior 606 in FIG. 6 in accordance with some embodiments. In some embodiments, the score is based at least on one or more attributes associated with a worker. The one or more attributes associated with the worker may be based at least on whether the worker has erroneously flag one or more sales transactions in one or more previous verifications as including at least one unpaid item. For example, at example 802, a worker's behavior may often cause a sales transaction and/or a shopping container 302 to be flagged as shrink when all items associated with the sales transaction and/or stored in the shopping container 302 have been paid for by a first customer. In such example, the trained machine learning model 318 may not update the first customer's associated member behavior 604 in such a way that negatively affects the trained machine learning model's 318 subsequent determination and/or assignment of a score to associate with a subsequent sales transaction of the first customer.

In an illustrative non-limiting example, at 806, a member 1/customer may approach an exit with a shopping container 302, such as a cart or a basket. Alternatively or in addition, at 808, an exit associate, such as a worker proximate an exit of a store, may inaccurately flag the cart or the basket as a shrink (false positive, FP). For example, the trained machine learning model 318 may determine whether the worker has scanned the assigned quantity of items to be verified by determining the time that has elapsed between the time the next to the last item was scanned and the time the last item was scanned. By one approach, if the elapsed time is greater than the elapsed time threshold, the trained machine learning model 318 may determine that the last item was scanned during a subsequent verification. Thus, the worker did not verify the quantity of items as instructed.

As such, at 810, the false positive may be identified and fed back to the ExitML Model 318 to learn. Alternatively or in addition, at 812, the ExitML Model 318 may not penalize the member 1/customer's next visit to a store, such as a retail store club, based on the false positive learning. For example, the trained machine learning model 318 may not update the corresponding customer's associated member behavior 604 in such a way that negatively affects the trained machine learning model's 318 subsequent determination and/or assignment of a score to associate with a subsequent sales transaction of the corresponding customer. Alternatively or in addition, the trained machine learning model 318 may update the worker's associated associate behavior 606 in such a way that it will not negatively affect the trained machine learning model's 318 subsequent determination and/or assignment of a score to associate with a subsequent sales transaction verified by the same worker.

In another illustrative non-limiting example 804, a worker's behavior may accurately flag a sales transaction and/or a shopping container 302 of a second customer as shrink. In such example, the trained machine learning model 318 may update the second customer's associated member behavior 604 in such a way that negatively affects the trained machine learning model's 318 subsequent determination and/or assignment of a score to associate with a subsequent sales transaction of the second customer.

For example, at 814, a member 2/another customer may approach an exit with a shopping container 302, such as a cart or a basket. Alternatively or in addition, at 816, another exit associate may accurately flag the cart or the basket as shrink (true positive, TP). Alternatively or in addition, at 818, the true positive may be identified and fed back to the ExitML Model 318 to learn. Alternatively or in addition, at 820, the ExitML Model 318 may increase the risk score of the member 2/another user's next visit to a store, such as a retail store club, based on the true positive learning.

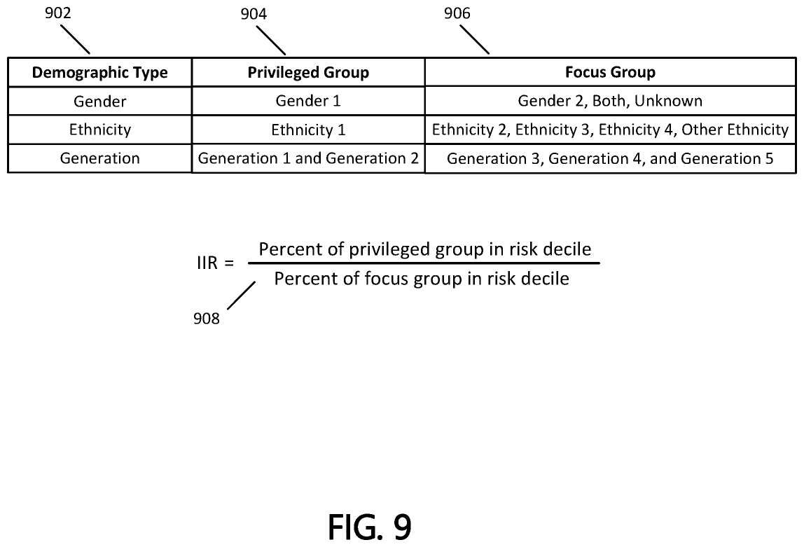

FIG. 9 shows an exemplary attribute used in a verification of fairness in auditing prior purchases at a store in accordance with some embodiments. In some embodiments, the trained machine learning model 318 may automatically assess fairness in the assignment of the score through analysis of historical data of the assigned score and corresponding demographic types associated with customers in the store. In one example, the trained machine learning model 318 may automatically assess fairness in the assignment of the score by continuous self-improvement. For example, the self-improvement may be based on a periodic analysis of historical data of a correlation of the assigned score to the sales transaction and corresponding demographic types associated with customers in the store. For example, the trained machine learning model 318 may be continuously improved by assessing the trained machine learning model's 318 fairness for the following demographic types 902—gender, ethnicity, and generation. In some embodiments, the assessment of the trained machine learning model's 318 fairness may be determined based on calculating Inverse Impact Ratio (IIR) per decile for each focus group 906 within each demographic type 902 using the IIR formula 908. For example, the trained machine learning model 318 may determine a ratio of the percent of privileged group 904 in risk decile over the percent of focus group 906 in risk decile. In some embodiments, the IIR Values may be interpreted as follows: greater than or equal to 0.8, the trained machine learning model 318 is fair; between 0.6 and 0.8, the result may need to be justified or reassessed before the trained machine learning model 318 is to be used in auditing purchases at a store; less than 0.6, the trained machine learning model 318 needs to be retrained. In some embodiments, the AI Fairness analysis may be performed quarterly and/or when a model with new features is trained. In some embodiments, the AI fairness results may be reviewed with internal teams of the retailer.

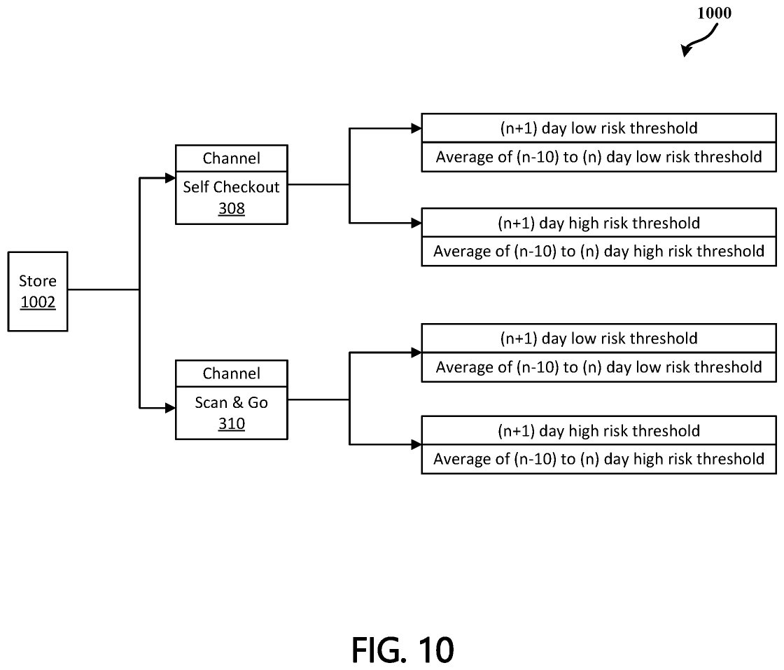

FIG. 10 shows an illustrative example of using dynamic threshold approach 1000 in auditing purchases at a store in accordance with some embodiments. In some embodiments, in the dynamic threshold approach 1000, the score may be correlated with the quantity of items to be verified by a worker prior to a customer leaving the store. In some embodiments, the control circuit 102 assigns the quantity of items to be verified based on at least the score and at least one of a time of day, a day of week, a store, and an amount of customer traffic in the store. For example, a correlation of the score with the quantity of items may be varied based on at least one of a day of a week or the store. In an illustrative non-limiting example, to stabilize the resulting probability of distribution of the trained machine learning model 318 for each day and/or for each store, and each transaction type, the control circuit 102 may implement the dynamic threshold approach 1000. In some embodiments, the low risk and high risk thresholds for next business day are automatically calculated by analyzing score distribution for the last 10 days for each club and transaction type. The dynamic threshold approach 1000 allows the trained machine learning model 318 to maintain variable scan composition (e.g., 40%—2 scans, 40%—3 scans, 20%—4 scans), minimize impact of data drift, and improve machine learning model's 318 fairness.

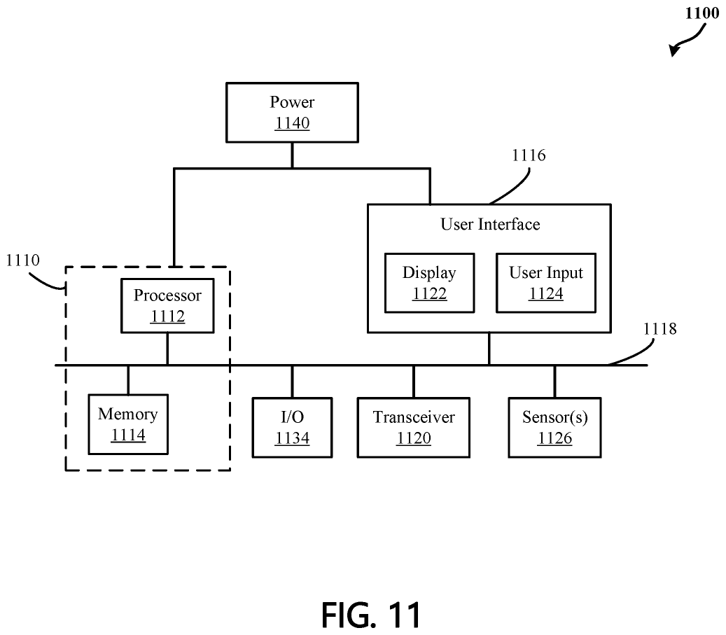

Further, the circuits, circuitry, systems, devices, processes, methods, techniques, functionality, services, servers, sources and the like described herein may be utilized, implemented and/or run on many different types of devices and/or systems. FIG. 11 illustrates an exemplary system 1100 that may be used for implementing any of the components, circuits, circuitry, systems, functionality, apparatuses, processes, or devices of the system 100 of FIG. 1, the method 200 of FIG. 2, the method 400 of FIG. 4, the method 500 of FIGS. 5A-5B, and/or other above or below mentioned systems or devices, or parts of such circuits, circuitry, functionality, systems, apparatuses, processes, or devices. For example, the system 1100 may be used to implement some or all of the system for auditing purchases at a store, a control circuit 102, sensors (not shown), user interface 106, electronic device/s 108, a communication network 104, database/s (not shown) (e.g. first database, second database, third database, to name a few), and/or other such components, circuitry, functionality and/or devices. However, the use of the system 1100 or any portion thereof is certainly not required.

By way of example, the system 1100 may comprise a processor module (or a control circuit) 1112, memory 1114, and one or more communication links, paths, buses or the like 1118. Some embodiments may include one or more user interfaces 1116, and/or one or more internal and/or external power sources or supplies 1140. The control circuit 1112 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1112 can be part of control circuitry and/or a control system 1110, which may be implemented through one or more processors with access to one or more memory 1114 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1100 may be used to implement one or more of the above or below, or parts of, components, circuits, systems, processes and the like. For example, the system 1100 may implement the system for auditing purchases at a store with the control circuit 102 being the control circuit 1112.

The user interface 1116 can allow a user to interact with the system 1100 and receive information through the system. In some instances, the user interface 1116 includes a display 1122 and/or one or more user inputs 1124, such as buttons, touch screen, track ball, keyboard, mouse, etc., which can be part of or wired or wirelessly coupled with the system 1100. Typically, the system 1100 further includes one or more communication interfaces, ports, transceivers 1120 and the like allowing the system 1100 to communicate over a communication bus, a distributed computer and/or communication network (e.g., a local area network (LAN), the Internet, wide area network (WAN), etc.), communication link 1118, other networks or communication channels with other devices and/or other such communications or combination of two or more of such communication methods. Further the transceiver 1120 can be configured for wired, wireless, optical, fiber optical cable, satellite, or other such communication configurations or combinations of two or more of such communications. Some embodiments include one or more input/output (I/O) interface 1134 that allow one or more devices to couple with the system 500. The I/O interface can be substantially any relevant port or combinations of ports, such as but not limited to USB, Ethernet, or other such ports. The I/O interface 1134 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1126 to provide information to the system and/or sensor information that is communicated to another component, such as the control circuit 102, the sensor/s, the user interface 106, the electronic device/s 108, the communication network 104, the database/s, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1100 comprises an example of a control and/or processor-based system with the control circuit 1112. Again, the control circuit 1112 can be implemented through one or more processors, controllers, central processing units, logic, software and the like. Further, in some implementations the control circuit 1112 may provide multiprocessor functionality.

The memory 1114, which can be accessed by the control circuit 1112, typically includes one or more processor readable and/or computer readable media accessed by at least the control circuit 1112, and can include volatile and/or nonvolatile media, such as RAM, ROM, EEPROM, flash memory and/or other memory technology. Further, the memory 1114 is shown as internal to the control system 1110; however, the memory 1114 can be internal, external or a combination of internal and external memory. Similarly, some or all of the memory 1114 can be internal, external or a combination of internal and external memory of the control circuit 1112. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 1114 can store code, software, executables, scripts, data, content, lists, programming, programs, log or history data, user information, customer information, product information, and the like. While FIG. 11 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for auditing purchases at a store, the system comprising:
a control circuit configured to:
receive purchase data corresponding to a plurality of items collected in the store and purchased by a customer in a sales transaction using a point of sale mechanism;
assign a score to the sales transaction;
assign, based on at least the score, a quantity of items to be verified by a worker prior to the customer leaving the store, the quantity comprising a number and selected from any one of a plurality of numbers; and
output transaction data comprising at least a transaction identifier associated with the sales transaction and the quantity of the items to be verified by the worker; and
a user interface operable on an electronic device associated with the worker, wherein the worker is proximate an exit of the store, wherein the user interface is configured to:
receive the transaction data from the control circuit; and
display instructions to the worker indicating the quantity of items of the sales transaction to be verified.

2. The system of claim 1, wherein the user interface is further configured to:
obtain a transaction identifier associated with the sales transaction from a receipt presented to the worker by the customer; and
retrieve the quantity of items of the sales transaction from the transaction data having a matching transaction identifier.

3. The system of claim 1, further comprising a shopping container configured to store the plurality of items collected and purchased by the customer in the store, wherein the score is associated with the shopping container.

4. The system of claim 1, wherein the instructions displayed to the worker do not specify particular items of the plurality of items to verify.

5. The system of claim 1, wherein the point of sale mechanism comprises at least one of a self-checkout station, a cashier assisted checkout station, and a mobile checkout application for use with an electronic device of the customer.

6. The system of claim 1, wherein the control circuit is further configured to output transaction data for each of a plurality of sales transactions to the user interface, wherein the user interface is configured to receive and store the transaction data for each of the plurality of sales transactions.

7. The system of claim 1, wherein the control circuit is configured to assign the score based on at least one or more of: a composition of the plurality of items, one or more attributes associated with the store, and one or more attributes associated with the worker.

8. The system of claim 1, wherein the score is based at least on a determination that a threshold portion of the plurality of items belongs to a category of items.

9. The system of claim 8, wherein each category of categories of items is associated with a corresponding quantity of items to be verified by the worker prior to the customer leaving the store.

10. The system of claim 1, wherein the control circuit is configured to assign the quantity of items to be verified based on at least the score and at least one of a time of day, a day of week, a store, and an amount of customer traffic in the store.

11. The system of claim 1, wherein the control circuit is configured to assign the score by executing a trained machine learning model.

12. The system of claim 11, wherein the trained machine learning model is configured to automatically assess fairness in the assignment of the score through an analysis of the assigned score and corresponding demographic types associated with customers in the store.

13. The system of claim 1, wherein the score is based at least on one or more attributes associated with the worker, and wherein the one or more attributes associated with the worker is based at least on whether the worker has erroneously flagged one or more sales transactions in one or more previous verifications as including at least one unpaid item.

14. The system of claim 1, wherein the user interface is configured to:
receive scan data corresponding to each of the quantity of items from a scanner of the electronic device;
determine whether the scan data of each of the items matches ones of the plurality of items purchased by the customer in the sales transaction;
output and display, in an event the scan data of the quantity of items matches with the plurality of items, a first notification to the worker via the user interface that the sales transaction is verified; and
output and display, in an event the scan data of at least one item does not match the plurality of items, a second notification to the worker via the user interface that an item has not been paid for by the customer.

15. A method for auditing purchases at a store, the method comprising:
receiving, by a control circuit, purchase data corresponding to a plurality of items collected in the store and purchased by a customer in a sales transaction using a point of sale mechanism;
assigning, by the control circuit, a score to the sales transaction;
assigning, by the control circuit and based on at least the score, a quantity of items to be verified by a worker prior to the customer leaving the store;
outputting, by the control circuit, transaction data comprising at least a transaction identifier associated with the sales transaction and the quantity of the items to be verified by the worker;
receiving, from the control circuit and at a user interface operable on an electronic device associated with the worker proximate an exit of the store, the transaction data; and
displaying, by the user interface, instructions to the worker indicating the quantity of items of the sales transaction to be verified.

16. The method of claim 15, wherein the score is based at least on a determination that a threshold portion of the plurality of items belongs to a category of items.

17. The method of claim 16, wherein each category of categories of items is associated with a corresponding quantity of items to be verified by the worker prior to the customer leaving the store.

18. The method of claim 15, further comprising assigning, by the control circuit, the quantity of items to be verified based on at least the score and at least one of a time of day, a day of week, a store, and an amount of customer traffic in the store.

19. The method of claim 15, further comprising assigning, by the control circuit executing a trained machine learning model, the score.

20. The method of claim 15, wherein the score is based at least on one or more attributes associated with the worker, and wherein the one or more attributes associated with the worker is based at least on whether the worker has erroneously flagged one or more sales transactions in one or more previous verifications as including at least one unpaid item.
